(19) United States
(12) Patent Application Publication
(10) Pub. No.: US 2025/0141573 A1
(43) Pub. Date: May 1, 2025

(54) DEVICE FOR CONTROLLING SERVICE ADMISSION IN WIRELESS COMMUNICATION SYSTEM AND METHOD THEREOF

(71) Applicant: ELECTRONICS AND TELECOMMUNICATIONS RESEARCH INSTITUTE, Daejeon (KR)

(72) Inventors: Keunyoung KIM, Daejeon (KR); Young Jo KO, Daejeon (KR); Woo Yong LEE, Daejeon (KR)

(73) Assignee: ELECTRONICS AND TELECOMMUNICATIONS RESEARCH INSTITUTE, Daejeon (KR)

(21) Appl. No.: 18/932,607

(22) Filed: Oct. 30, 2024

(30) Foreign Application Priority Data
Nov. 1, 2023 (KR) 10-2023-0149256

(51) Int. Cl. H04B 17/309; H04B 7/0426; H04B 7/06

(52) U.S. Cl. CPC H04B 17/346; H04B 7/043; H04B 7/0617

(57) ABSTRACT

A device for controlling service admission in a wireless communication system and a method thereof are proposed. The method includes obtaining a use request message for at least one service from a plurality of user equipments (UEs), determining whether Signal-to-Interference-plus-Noise Ratios (SINRs) corresponding to the plurality of UEs are different from each other in response to the use request message, determining whether a first condition for power allocation corresponding to specific UE among the plurality of UEs is satisfied when the SINRs corresponding to the plurality of UEs are different from each other, determining whether a second condition for the power allocation corresponding to the specific UE is satisfied when the SINRs corresponding to the plurality of UEs are different from each other, and providing a use response message for the at least one service to the specific UE when the specific UE satisfies the first and second conditions.

### CROSS REFERENCE TO RELATED APPLICATION

The present application claims priority to Korean Patent Application No. 10-2023-0149256, filed Nov. 1, 2023, the entire contents of which are incorporated herein for all purposes by this reference.

### BACKGROUND OF THE INVENTION

### Field of the Invention

The present disclosure is a technology related to a wireless communication system and, more particularly, to a technology for identifying and determining whether service is available or not in a wireless communication system in which users exchange data by connecting to a multiple-antenna system, a plurality of access points, or transmission reception points.

### Description of the Related Art

In a wireless communication system, it is important to determine whether service is available within an available power limit for each user. Call admission control determines whether service is available or not, and then determines whether to admit a new service request or not. To this end, it is required to determine whether power allocation satisfying signal-to-interference-plus-noise ratios required by the service is available or not. Whether such power allocation is available or not may be easily determined through a Perron-Frobenius theorem. A power allocation method using the Perron-Frobenius theorem was the first to provide a fundamental theory of power allocation in a code division multiple access system, which is a second-generation mobile communication system.

### SUMMARY OF THE INVENTION

An objective of the present disclosure is to provide smooth services to existing users and users requesting new services by calculating a spectral radius of a matrix composed of requested signal-to-interference-plus-noise ratios, beamforming vectors, and channel gains, and allocated power to determine whether to accept the services or not.

According to an exemplary embodiment of the present disclosure, there is provided a method of operating a base station (BS) in a wireless communication system, the method including: obtaining a use request message for at least one service from a plurality of user equipments (UEs); determining whether Signal-to-Interference-plus-Noise Ratios (SINRs) corresponding to the plurality of UEs are different from each other or not in response to the use request message; determining whether a first condition for power allocation corresponding to specific UE among the plurality of UEs is satisfied or not in a case where the SINRs corresponding to the plurality of UEs are different from each other; determining whether a second condition for the power allocation corresponding to the specific UE is satisfied or not in the case where the SINRs corresponding to the plurality of UEs are different from each other; and providing a use response message for the at least one service to the specific UE in a case where the specific UE satisfies the first condition and the second condition.

In addition, whether the first condition is satisfied or not may be determined on the basis of a spectral radius of a matrix composed of channels and beamforming vectors, which are corresponding to the specific UE, and the matrix may be related to a diagonal matrix regarding a required SINR corresponding to the specific UE.

In addition, whether the first condition is satisfied or not may be determined on the basis of [Equation 1] below:

$$ρ ( Γ A ) < 1 \qquad [ Equation l ]$$

where, Γ is the diagonal matrix having as diagonal elements the required Signal-to-Interference-plus-Noise Ratio corresponding to the specific UE, and ρ(A) is the spectral radius of matrix A composed of the channels and beamforming vectors, which are corresponding to the specific UE.

In addition, the determining of whether the second condition is satisfied or not may include: determining optimal power allocation corresponding to the specific UE; and determining whether the optimal power allocation is within a power allocation range available to the plurality of UEs.

According to the exemplary embodiment of the present disclosure, there is provided a device for a base station (BS) in a wireless communication system, the device including: a transceiving unit; and at least one control unit operably connected to the transceiving unit,
wherein the at least one control unit may be configured to obtain a use request message for at least one service from a plurality of user equipments (UEs), determine whether Signal-to-Interference-plus-Noise Ratios (SINRs) corresponding to the plurality of UEs are different from each other or not in response to the use request message, determine whether a first condition for power allocation corresponding to specific UE among the plurality of UEs is satisfied or not in a case where the SINRs corresponding to the plurality of UEs are different from each other, determine whether a second condition for the power allocation corresponding to the specific UE is satisfied or not in the case where the SINRs corresponding to the plurality of UEs are different from each other, and provide a use response message for the at least one service to the specific UE in a case where the specific UE satisfies the first condition and the second condition.

In addition, whether the first condition is satisfied or not may be determined on the basis of a spectral radius of a matrix composed of channels and beamforming vectors, which are corresponding to the specific UE, and the matrix may be related to a diagonal matrix regarding a required SINR corresponding to the specific UE.

In addition, whether the first condition is satisfied or not may be determined on the basis of [Equation 1] below:

$$ρ ( Γ A ) < 1 \qquad [ Equation l ]$$

where, Γ is the diagonal matrix having as diagonal elements the required Signal-to-Interference-plus-Noise Ratio corresponding to the specific UE, and ρ(A) is the spectral radius of matrix A composed of the channels and beamforming vectors, which are corresponding to the specific UE.

In addition, in order to determine whether the second condition is satisfied or not, the at least one control unit may be configured to determine optimal power allocation corresponding to the specific UE, and determine whether the optimal power allocation is within a power allocation range available to the plurality of UEs.

According to an exemplary embodiment of the present disclosure, there is provided a method of operating user equipment (UE) in a wireless communication system, the method including: providing a use request message for at least one service to a base station (BS); and obtaining a use response message for the at least one service from the base station in response to the use request message, wherein the use request message may be generated in a case where a first condition for power allocation corresponding to the UE is satisfied and a second condition for the power allocation corresponding to the UE is satisfied.

In addition, whether the first condition is satisfied or not may be determined on the basis of a spectral radius of a matrix composed of channels and beamforming vectors, which are corresponding to specific UE, and the matrix may be related to a diagonal matrix regarding a required SINR corresponding to the specific UE.

In addition, whether the first condition is satisfied or not may be determined on the basis of [Equation 1] below:

$$ρ ( Γ A ) < 1 \qquad [ Equation l ]$$

where, Γ is a diagonal matrix having as diagonal elements a required Signal-to-Interference-plus-Noise Ratio corresponding to specific UE, and ρ(A) is a spectral radius of matrix A composed of channels and beamforming vectors, which are corresponding to the specific UE.

In addition, the determining of whether the second condition is satisfied or not may include determining whether optimal power allocation corresponding to the UE is within a power allocation range available to a plurality of UEs, wherein each of the plurality of UEs may be UE that has transmitted the use request message for the at least one service to the base station.

According to an exemplary embodiment of the present disclosure, there is provided a device for user equipment (UE) in a wireless communication system, the device is configured to provide a use request message for at least one service to a base station (BS), and obtain a use response message for the at least one service from the base station in response to the use request message, wherein the use request message may be generated in a case where a first condition for power allocation corresponding to the UE is satisfied and a second condition for the power allocation corresponding to the UE is satisfied.

In addition, whether the first condition is satisfied or not may be determined on the basis of a spectral radius of a matrix composed of channels and beamforming vectors, which are corresponding to specific UE, and the matrix may be related to a diagonal matrix regarding a required SINR corresponding to the specific UE.

In addition, whether the first condition is satisfied or not may be determined on the basis of [Equation 1] below:

$$ρ ( Γ A ) < 1 \qquad [ Equation l ]$$

where, Γ is a diagonal matrix having as diagonal elements a required Signal-to-Interference-plus-Noise Ratio corresponding to specific UE, and ρ(A) is a spectral radius of matrix A composed of channels and beamforming vectors, which are corresponding to the specific UE.

In addition, in order to determine whether the second condition is satisfied or not, the at least one control unit may be further configured to determine whether optimal power allocation corresponding to the UE is within a power allocation range available to a plurality of UEs, wherein each of the plurality of UEs may be UE that has transmitted the use request message for the at least one service to the base station.

The present disclosure has an advantage in that smooth services is provided to existing users and users requesting new services by calculating a spectral radius of a matrix composed of requested signal-to-interference-plus-noise ratios, beamforming vectors, and channel gains, and allocated power to determine whether to accept the services or not.

### BRIEF DESCRIPTION OF THE DRAWINGS

FIG. 1 is a view illustrating a primitive matrix used in a wireless communication system according to an exemplary embodiment of the present disclosure.

FIG. 2 a view illustrating an irreducible matrix used in the wireless communication system according to the exemplary embodiment of the present disclosure.

FIG. 3 is a view illustrating a flowchart regarding an operation of a base station device according to the exemplary embodiment of the present disclosure.

FIG. 4 is a view illustrating another flowchart regarding an operation of a base station device according to the exemplary embodiment of the present disclosure.

### DETAILED DESCRIPTION OF THE INVENTION

Phrases such as “in some exemplary embodiments” or “in one exemplary embodiment” that appear in various places in the present specification do not necessarily all refer to the same exemplary embodiment.

Some exemplary embodiments of the present disclosure may be represented by functional block components and various processing steps. Some or all of these functional blocks may be implemented in various numbers of hardware and/or software components that perform specific functions. For example, the functional blocks of the present disclosure may be implemented by one or more microprocessors, or may be implemented by circuit components for prescribed functions. In addition, for example, the functional blocks of the present disclosure may be implemented in various programming or scripting languages. The functional blocks may be implemented as algorithms that are executed on one or more processors. In addition, the present disclosure may employ conventional technologies for electronic environment setup, signal processing, and/or data processing. Terms such as “mechanism”, “element”, “means”, and “configuration” may be used broadly and are not limited to mechanical and physical components.

In addition, connection lines or connection members between components shown in the drawings merely exemplify functional connections and/or physical or circuit connections. In an actual device, connections between components may be represented by various replaceable or additional functional connections, physical connections, or circuit connections.

The present disclosure proposes a power allocation method for providing signal-to-interference-plus-noise ratios required in an uplink of a wireless communication multiple-antenna system on the basis of the Perron-Frobenius theorem, and proposes a call admission control method of determining whether service provision is available or not by identifying whether available power allocation is possible or not and total available power of each user.

### <Multiple-Antenna System>

Multiple antenna technology has been a key technology for improving performance in wireless communication systems for over the past 50 years. By using the multiple antenna technology, various effects may be obtained such that frequency efficiency is improved by using multiple antennas to simultaneously transmit different data to the same time and frequency resources, safety is improved by transmitting data through multiple paths, or power requirements are reduced or a communication radius is increased by transmitting signals after adjusting the angles of signals at a time of transmission and reception. The multiple antenna technology is developed into massive antenna technology in 5G NR mobile communication systems.

In order to present various wireless communication algorithms such as power allocation of a multiple-antenna system and evaluate their performance, mathematical modeling therefor is required. In the present disclosure, modelling is conducted as follows.

In a wireless communication system configured with L antennas, a situation is assumed such that K users having a single antenna transmit signals in an uplink and a massive MIMO has a condition where L≥K. Since each user transmits signals through a single antenna, each signal may be expressed as Equation 1 below with power allocated without transmission beamforming.

$$x = [ \begin{matrix}{x}_{1} \\ ⋮ \\ {x}_{K}\end{matrix} ] = \sqrt{P} s = [ \begin{matrix}\sqrt{{p}_{1}} {s}_{1} \\ ⋮ \\ \sqrt{{p}_{K}} {s}_{K}\end{matrix} ] \qquad [ Equation 1 ]$$

Here, s is a transmission signal vector composed of k user signals sₖ, and the power allocated to each user may be 0≤pₖ≤p^{max} and \sqrt{P}=diag(\sqrt{p₁}, \sqrt{p₂}, . . . , \sqrt{p_{K}}).

The signals received through the uplink may be expressed as Equation 2 below.

$$y = {\sum }_{k = 1}^{K} {h}_{k} {x}_{k} = H \sqrt{P} s + z = [ \begin{matrix}{\sum }_{k = 1}^{K} {h}_{1 k} \sqrt{{p}_{k}} {s}_{k} + {z}_{1} \\ {\sum }_{k = 1}^{K} {h}_{2 k} \sqrt{{p}_{k}} {s}_{k} + {z}_{2} \\ ⋮ \\ {\sum }_{k = 1}^{K} {h}_{Lk} \sqrt{{p}_{k}} {s}_{k} + {z}_{L}\end{matrix} ] \qquad [ Equation 2 ]$$

Here, H is a channel matrix composed of h_{l,k}, which is a channel gain between a user k and an antenna element l, and is assumed to be full rank.

The signals received through the uplink may be estimated by using a reception beamforming vector F^{H} as shown in Equation 3 below.

$$\hat{s} = {F}^{H} y = {F}^{H} H \sqrt{P} s + {F}^{H} z = [ \begin{matrix}{f}_{1}^{H} y \\ {f}_{2}^{H} y \\ ⋮ \\ {f}_{K}^{H} y\end{matrix} ] \qquad [ Equation 3 ]$$

A signal-to-interference-plus-noise ratio of the user k is expressed in Equation 4 below.

$$\begin{matrix}{SINR}_{k} = \frac{{p}_{k} {f}_{k}^{H} {h}_{k} {h}_{k}^{H} {f}_{k}}{{f}_{k}^{H} ( {\sum }_{i = 1 , i \neq k}^{K} {p}_{i} {h}_{i} {h}_{i}^{H} + {σ}^{2} I ) {f}_{k}} \\ = \frac{{p}_{k} {\vert {f}_{k}^{H} {h}_{k} \vert}^{2}}{{\sum }_{i = 1 , i \neq k}^{K} {p}_{i} {\vert {f}_{k}^{H} {h}_{i} \vert}^{2} + {σ}^{2}}\end{matrix} \qquad [ Equation 4 ]$$

The signal-to-interference-plus-noise ratio takes the form of a Rayleigh quotient, so a user optimal beamforming vector fₖ that maximizes this quantity may be obtained in the form of minimum mean square error (MMSE) as shown in Equation 5 below.

$${f}_{k} = \frac{{( {HPH}^{H} - {p}_{k} {h}_{k} {h}_{k}^{H} + {σ}^{2} I )}^{- 1} {h}_{k}}{‖ {( {HPH}^{H} - {p}_{k} {h}_{k} {h}_{k}^{H} + {σ}^{2} I )}^{- 1} {h}_{k} ‖} \qquad [ Equation 5 ]$$

The maximum signal-to-noise ratio that may be obtained through the optimal beamforming vector may be obtained as in Equation 6 below.

$$S I N {R}_{k}^{U L} = {p}_{k} {{h}_{k}^{H} ( H P {H}^{H} - {p}_{k} {h}_{k} {h}_{k}^{H} + {σ}^{2} I )}^{- 1} {h}_{k} \qquad [ Equation 6 ]$$

In the wireless communication system, a required transmission rate is generally expressed as a required signal-to-interference-plus-noise ratio. For example, in the wireless communication system, when all users have the same signal-to-interference-plus-noise ratio, Equation 7 below should be satisfied.

$$\begin{matrix}{γ}^{U L} = \frac{{p}_{k} {\vert {f}_{k}^{H} {h}_{k} \vert}^{2}}{{\sum }_{i = 1 , i \neq k}^{K} {p}_{i} {\vert {f}_{k}^{H} {h}_{i} \vert}^{2} + {σ}^{2}} , & ∀ k .\end{matrix} \qquad [ Equation 7 ]$$

Equation 7 above may be summarized as Equation 8 below.

$$\begin{matrix}{p}_{k} - {\sum }_{i \neq k}^{K} {p}_{i} \frac{{γ}^{U L} \vert {f}_{k}^{H} {h}_{i} {\vert}^{2}}{\vert {f}_{k}^{H} {h}_{k} {\vert}^{2}} = \frac{{γ}^{U L} {σ}^{2}}{\vert {f}_{k}^{H} {h}_{k} {\vert}^{2}} , & ∀ k .\end{matrix} \qquad [ Equation 8 ]$$

When this is expressed in a matrix form, Equation 8 is as shown in Equation 9 below.

$$( I - {γ}^{U L} A ) p = {γ}^{U L} b \qquad [ Equation 9 ]$$

Here, p=[p1, p2, . . . , pk], and A, which is a K×K matrix, may be a matrix having positive elements on a diagonal thereof, as shown in Equation 10 below.

$${a}_{i j} = \{ \begin{matrix}0 & if i = j , \\ \frac{{\vert {f}_{i}^{H} {h}_{j} \vert}^{2}}{{\vert {f}_{i}^{H} {h}_{i} \vert}^{2}} & if i \neq j ,\end{matrix} \qquad [ Equation 10 ]$$

In addition, vector b is expressed in Equation 11 below.

$$b = {[ \frac{{σ}^{2}}{\vert {f}_{1}^{H} {h}_{1} {\vert}^{2}} , \frac{{σ}^{2}}{\vert {f}_{2}^{H} {h}_{2} {\vert}^{2}} , … , \frac{{σ}^{2}}{\vert {f}_{K}^{H} {h}_{K} {\vert}^{2}} ]}^{H} . \qquad [ Equation 11 ]$$

The equation composed of the required signal-to-interference-plus-noise ratio may be expressed as a linear function for power, and accordingly, it may be expressed as a determinant. In addition, each matrix is composed of elements that are zeros or positive numbers. For matrices composed of the zeros or positive numbers, it is possible to devise a method for power allocation and service admission control when the Perron-Frobenius theorem is used.

### <Perron-Frobenius Theorem>

Most measurable quantities such as time, probability, weight, and power are zeros or positive numbers. In addition, the relationships between these quantities are often expressed as a linear iterative calculation, as shown in Equation 12 below.

$${x}^{n + 1} = A {x}^{n} \qquad [ Equation 12 ]$$

The Perron-Frobenius theorem presents the properties of eigenvalue and eigenvector for an irreducible matrix among these matrices.

When satisfying the conditions of Equation 13 below, a square matrix A with zeros or positive numbers as elements may be referred to as a primitive matrix.

$$∃ n ∀ ( i , j ) : {a}_{i , j}^{n} > 0 \qquad [ Equation 13 ]$$

In addition, when satisfying the conditions of Equation 14 below, the square matrix A may be referred to as an irreducible matrix.

$$∀ ( i , j ) ∃ n : {a}_{i , j}^{n} > 0 \qquad [ Equation 14 ]$$

For all (i,j) elements of the matrix, a primitive matrix should have the same n value that causes all the elements positive when the matrix is raised to the n-th power. Even though n is not the same, when there is an n that causes the elements to be positive in a matrix, it becomes an irreducible matrix, so all primitive matrices are irreducible matrices.

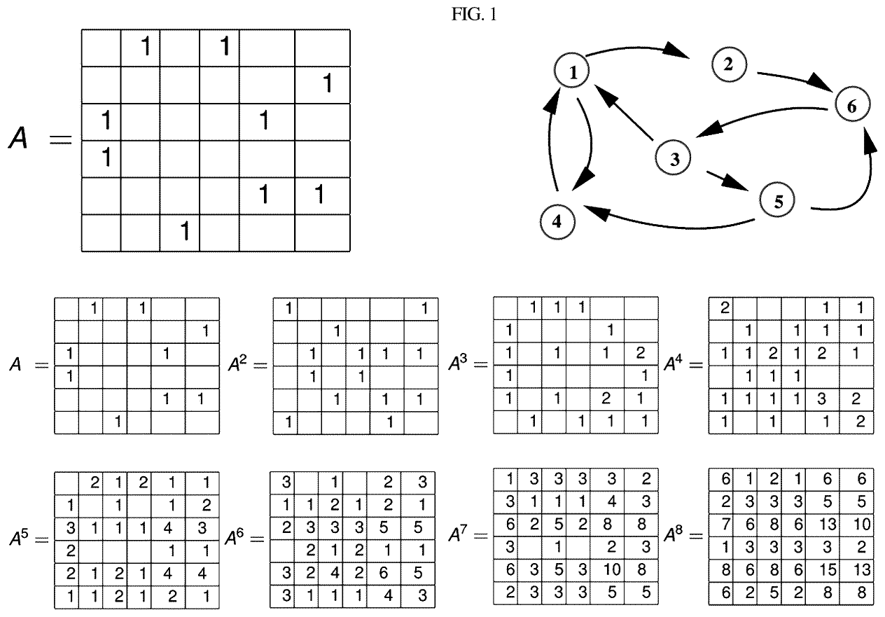

FIG. 1 is a view illustrating a primitive matrix used in a wireless communication system according to the exemplary embodiment of the present disclosure. Referring to FIG. 1, matrix A at the top is a primitive matrix because all elements thereof are positive through raising to the eighth power. Accordingly, the primitive matrix may also be called an irreducible matrix.

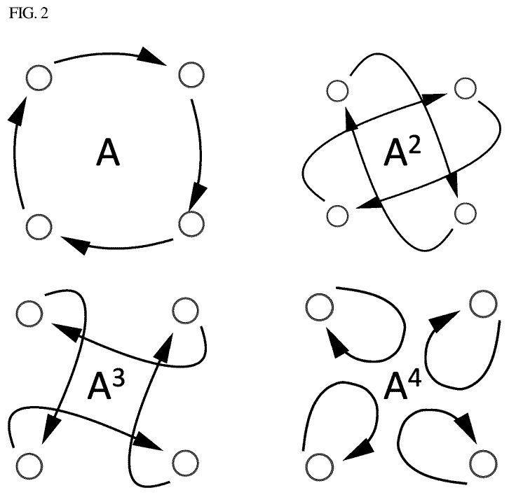

FIG. 2 is a view illustrating an irreducible matrix used in the wireless communication system according to the exemplary embodiment of the present disclosure. Referring to FIG. 2, the matrix means that there are paths from i to j when each of the (i,j) element of matrix A is 1, and may be an irreducible matrix because there are cases where all elements are positive while raising to the fourth power. However, this may not be a primitive matrix because not all elements are positive numbers by raising to n-th power with a natural number called fixed n.

The Perron-Frobenius theorem suggests that the following properties hold for an irreducible matrix, and ρ(A) may mean a spectral radius of matrix A, that is, the maximum value among absolute values of eigenvalues of matrix A.

The largest eigenvalue of matrix A, i.e., the spectral radius, is ρ(A)>0.

ρ(A) is an eigenvalue that does not have a multiple root.

There exists a single vector, that is, an eigen vector x, satisfying Ax=ρ(A)x, and all elements of x are positive numbers.

There exists a single vector y satisfying y^{T}A=ρ(A)y^{T} and all elements of y are positive numbers.

The Perron-Frobenius theorem may mean that when a matrix with zeros or positive numbers as elements is an irreducible matrix, there is only one eigenvector with a positive number as an element.

A wireless communication system according to the exemplary embodiment of the present disclosure may form a matrix having elements, which are zeros or positive numbers and composed of channels, beamforming vectors, and required signal-to-interference-plus-noise ratios, and may apply the Perron-Frobenius theorem to power allocation and service admission control for solving a problem of obtaining a power allocation value having a positive number.

The problem of obtaining a power allocation value is described in detail as follows.

The problem of obtaining the power for satisfying the same required signal-to-interference-plus-noise ratio for each user equipment (UE) may be expressed as Equation 15 below.

$$( I - {γ}^{U L} A ) p = {γ}^{U L} b \qquad [ Equation 15 ]$$

Since matrix A2 is a matrix with positive numbers as elements, this matrix is a primitive matrix and, accordingly, is an irreducible matrix. For vector b with positive elements, a necessary and sufficient condition for the existence of positive power allocation vector p may have to satisfy (I−γ^{UL}A)⁻¹≥0 for A≥0. To satisfy this, the necessary and sufficient condition may be expressed as Equation 16 below.

$$ρ ( A ) = 1 / {γ}^{U L} \qquad [ Equation 16 ]$$

When this condition is satisfied, a power vector allocated to each user is expressed in Equation 17 below.

$${\tilde{p}}^{*} = {γ ( I - γ A )}^{- 1} b \qquad [ Equation 17 ]$$

In a case when a required signal-to-interference-plus-noise ratio for each user is given by γₖ, a problem of obtaining power may be expressed as Equation 18 below.

$$( I - Γ A ) p = Γ b \qquad [ Equation 18 ]$$

Here, Γ may be a diagonal matrix in which a required signal-to-interference-plus-noise ratio for each user has γₖ as a diagonal element. The necessary and sufficient condition for having a positive power allocation value may be expressed as Equation 19 below.

$$ρ ( Γ A ) < 1 \qquad [ Equation 19 ]$$

When this condition is satisfied, a power vector allocated to each user may be expressed as Equation 20 below.

$${\tilde{p}}^{*} = {( I - Γ A )}^{- 1} Γ b \qquad [ Equation 20 ]$$

A problem of controlling whether each user's call is admitted or not by a wireless communication system according to the exemplary embodiment of the present disclosure will be described in detail as follows.

Call admission control in a wireless communication system means that the system determines whether service is available or not to a user requesting the service, so as to determine whether service admission is available or not. As an important factor in determining whether the service is available or not, it is required to determine whether the service is available or not to the user by using power currently available for each user.

For such determination, a spectral radius ρ(A) of matrix A composed of channels and beamforming vectors, signal-to-interference-plus-noise ratios γ^{UL} required for a service, and power vectors may be used to make the determination. That is, in a case where all users require the same signal-to-interference-plus-noise ratio, a condition that allows positive power to be allocated is as shown in Equation 21 below.

$$ρ ( A ) < 1 / {γ}^{UL} \qquad [ Equation 21 ]$$

That is, in a general case where required signal-to-interference-plus-noise ratios for respective users are different from each other, a condition that allows positive power to be allocated is as shown in Equation 22 below.

$$ρ ( Γ A ) < 1 \qquad [ Equation 22 ]$$

In a case where such a condition is satisfied and all the users are requiring the same signal-to-interference-plus-noise ratio, optimal power allocation is as shown in Equation 23 below.

$${\tilde{p}}^{*} = {γ ( I - γ A )}^{- 1} b \qquad [ Equation 23 ]$$

In a case where required signal-to-interference-plus-noise ratios for respective users are different from each other, optimal power allocation is as shown in Equation 24 below.

$${\tilde{p}}^{*} = {( I - Γ A )}^{- 1} Γ b \qquad [ Equation 24 ]$$

Since power allocation is available only within a power allocation range available to all the users, Equation 25 below should be satisfied.

$${\tilde{p}}^{*} \leq {p}^{max} \qquad [ Equation 25 ]$$

Since service is available only within available radio resources, service admission control is determined by whether the condition of Equation 26 below is satisfied or not.

$$ρ ( Γ A ) < 1 and {\tilde{p}}^{*} \leq {p}^{max} \qquad [ Equation 26 ]$$

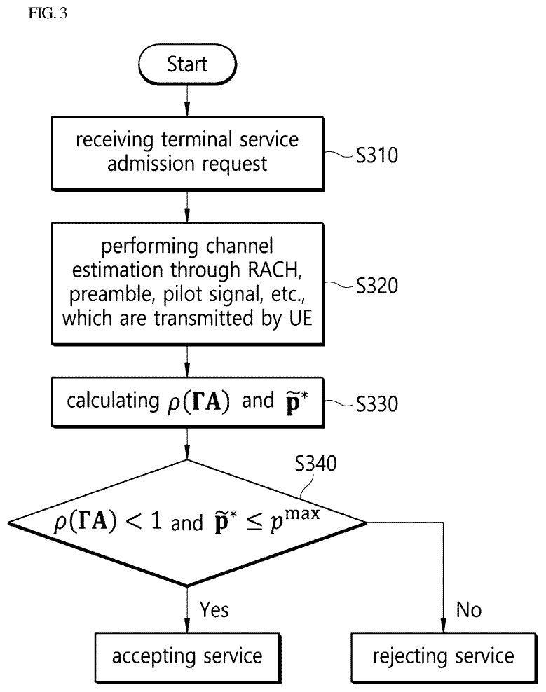

FIG. 3 is a view illustrating a flowchart regarding an operation of a base station device according to the exemplary embodiment of the present disclosure.

In step S310, a base station device receives a terminal service admission request.

A terminal may be UE corresponding to a user who is requesting a service. The service admission request may be a call admission request for at least one service and being provided to a base station device or a wireless communication system. For example, the base station device may receive a message corresponding to the service admission request from the UE.

In step S320, the base station device may perform channel estimation on the basis of signals transmitted by the UE.

Here, the signals transmitted by the UE may include RACH, a preamble, a pilot signal, a training sequence, a sounding signal, etc. The base station may perform a general operation for the channel estimation on the basis of the signals obtained from the UE.

In step S330, the base station device may determine information corresponding to a spectral radius of a specific diagonal matrix and a power vector allocated to the UE.

Here, the specific diagonal matrix is matrix A described above, and the spectral radius may mean the maximum value among the absolute values of eigenvalues of matrix A.

In addition, the information corresponding to the spectral radius of the specific diagonal matrix may be determined on the basis of the spectral radius of matrix A and the required SINR of the UE. In another example, a specific diagonal matrix may be determined on the basis of matrix A and a diagonal matrix F having the UE's required SINRs as diagonal elements.

In step S340, the base station device may determine whether or not information corresponding to the spectral radius of the specific diagonal matrix is less than 1 and whether or not a value corresponding to the power vector allocated to the UE is less than that of the maximum power.

Thereafter, the base station device may accept the service in a case where the information corresponding to the spectral radius of the specific diagonal matrix is less than 1 (i.e., a first condition is satisfied) and the value corresponding to the power vector allocated to the UE is less than that of the maximum power (i.e., a second condition satisfied). The base station device may reject the service in a case where at least one of the first condition and the second condition is not satisfied.

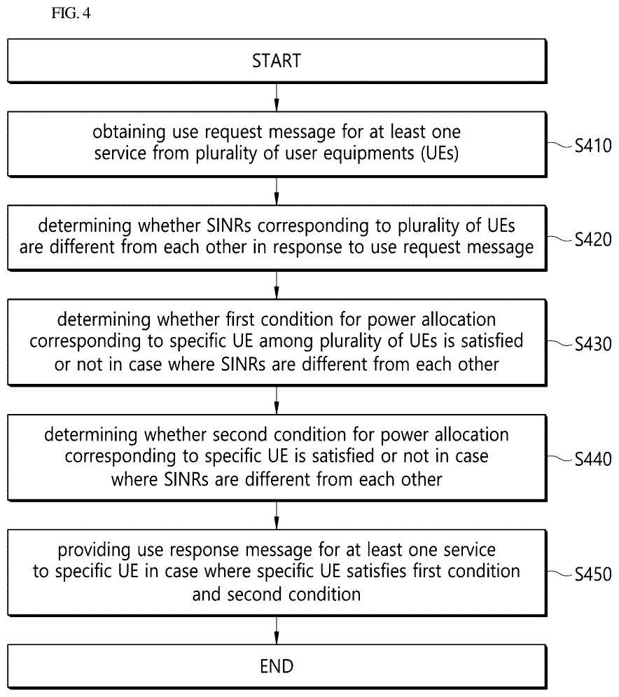

FIG. 4 is a view illustrating another flowchart regarding an operation of a base station device according to the exemplary embodiment of the present disclosure.

In step S410, the base station device obtains a use request message for at least one service from a plurality of user equipments (UEs).

Here, the use request message may be the same or similar to the service admission request received by the base station in step S310 of FIG. 3.

In step S420, the base station device determines whether SINRs corresponding to the plurality of UEs are different from each other in response to the use request message. The base station device may perform different operations depending on whether all the plurality of UEs that have transmitted respective use request messages are requesting the same SINR.

In step S430, in a case where the SINRs are different from each other, the base station device determines whether the first condition for power allocation corresponding to specific UE among the plurality of UEs is satisfied or not.

Whether the first condition is satisfied or not may be determined on the basis of a spectral radius of a matrix composed of channels and beamforming vectors, which are corresponding to the specific UE, and the matrix may be related to a diagonal matrix regarding a required SINR corresponding to the specific UE.

In addition, whether the first condition is satisfied or not may be determined on the basis of Equation 27 below.

$$ρ ( Γ A ) < 1 \qquad [ Equation 27 ]$$

Here, Γ may be a diagonal matrix having as diagonal elements the required signal-to-interference-plus-noise ratio corresponding to the specific UE, and ρ(A) may be the spectral radius of matrix A composed of the channels and beamforming vectors, which are corresponding to the specific UE.

In step S440, in a case where the SINRs are different from each other, the base station device determines whether the second condition for power allocation corresponding to the specific UE is satisfied or not.

Here, the operation of determining whether the second condition is satisfied or not may further include an operation of determining optimal power allocation corresponding to the specific UE and determining whether the optimal power allocation is within a power allocation range available to the plurality of UEs.

In step S450, in a case where the specific UE satisfies the first condition and the second condition, the base station device provides a use response message for at least one service to the specific UE.

The exemplary embodiment of the present disclosure described above is not only implemented through devices and methods, but may also be implemented through programs realizing the functions corresponding to the components of the exemplary embodiment of the present disclosure or a recording medium on which the programs are recorded.

Although the exemplary embodiments of the present disclosure have been described in detail above, the scope of the present disclosure is not limited thereto, and various modifications and improvements of those skilled in the art using the fundamental concepts of the present disclosure as defined in the following claims are also included in the scope of the present disclosure.

The above-described content is specific exemplary embodiments for realizing the present disclosure. The present disclosure will include not only the above-described exemplary embodiments, but also exemplary embodiments that are simply designed or may be easily changed. In addition, the present disclosure will also include techniques that may be easily modified and implemented by using the exemplary embodiments. Therefore, the scope of the present disclosure should not be limited to the above-described exemplary embodiments, but should be determined by the claims and equivalents of the present disclosure as well as the claims described below.

What is claimed is:

1. A method of operating a base station (BS) in a wireless communication system, the method comprising:
obtaining a use request message for at least one service from a plurality of user equipments (UEs);
determining whether Signal-to-Interference-plus-Noise Ratios (SINRs) corresponding to the plurality of UEs are different from each other or not in response to the use request message;
determining whether a first condition for power allocation corresponding to specific UE among the plurality of UEs is satisfied or not in a case where the SINRs corresponding to the plurality of UEs are different from each other;
determining whether a second condition for the power allocation corresponding to the specific UE is satisfied or not in the case where the SINRs corresponding to the plurality of UEs are different from each other; and
providing a use response message for the at least one service to the specific UE in a case where the specific UE satisfies the first condition and the second condition.

2. The method of claim 1, wherein whether the first condition is satisfied or not is determined on the basis of a spectral radius of a matrix composed of channels and beamforming vectors, which are corresponding to the specific UE, and the matrix is related to a diagonal matrix regarding a required SINR corresponding to the specific UE.

3. The method of claim 2, wherein whether the first condition is satisfied or not is determined on the basis of [Equation 1] below:
$$ρ ( Γ A ) < 1 \qquad [ Equation 1 ]$$
where, Γ is the diagonal matrix having as diagonal elements the required Signal-to-Interference-plus-Noise Ratio corresponding to the specific UE, and ρ(A) is the spectral radius of matrix A composed of the channels and beamforming vectors, which are corresponding to the specific UE.

4. The method of claim 1, wherein the determining of whether the second condition is satisfied or not comprises:
determining optimal power allocation corresponding to the specific UE; and
determining whether the optimal power allocation is within a power allocation range available to the plurality of UEs.

5. A device for a base station (BS) in a wireless communication system, the device comprising:
a transceiving unit; and
at least one control unit operably connected to the transceiving unit,
wherein the at least one control unit is configured to obtain a use request message for at least one service from a plurality of user equipments (UEs), determine whether Signal-to-Interference-plus-Noise Ratios (SINRs) corresponding to the plurality of UEs are different from each other or not in response to the use request message, determine whether a first condition for power allocation corresponding to specific UE among the plurality of UEs is satisfied or not in a case where the SINRs corresponding to the plurality of UEs are different from each other, determine whether a second condition for the power allocation corresponding to the specific UE is satisfied or not in the case where the SINRs corresponding to the plurality of UEs are different from each other, and provide a use response message for the at least one service to the specific UE in a case where the specific UE satisfies the first condition and the second condition.

6. The device of claim 5, wherein whether the first condition is satisfied or not is determined on the basis of a spectral radius of a matrix composed of channels and beamforming vectors, which are corresponding to the specific UE, and
the matrix is related to a diagonal matrix regarding a required SINR corresponding to the specific UE.

7. The device of claim 6, wherein whether the first condition is satisfied or not is determined on the basis of [Equation 1] below:
$$ρ ( Γ A ) < 1 \qquad [ Equation 1 ]$$
where, Γ is the diagonal matrix having as diagonal elements the required Signal-to-Interference-plus-Noise Ratio corresponding to the specific UE, and ρ(A) is the spectral radius of matrix A composed of the channels and beamforming vectors, which are corresponding to the specific UE.

8. The device of claim 5, wherein, in order to determine whether the second condition is satisfied or not, the at least one control unit is configured to determine optimal power allocation corresponding to the specific UE, and determine whether the optimal power allocation is within a power allocation range available to the plurality of UEs.

9. A method of operating user equipment (UE) in a wireless communication system, the method comprising:
providing a use request message for at least one service to a base station (BS); and
obtaining a use response message for the at least one service from the base station in response to the use request message,
wherein the use request message is generated in a case where a first condition for power allocation corresponding to the UE is satisfied and a second condition for the power allocation corresponding to the UE is satisfied.

10. The method of claim 9, wherein whether the first condition is satisfied or not is determined on the basis of a spectral radius of a matrix composed of channels and beamforming vectors, which are corresponding to specific UE, and
the matrix is related to a diagonal matrix regarding a required SINR corresponding to the specific UE.

11. The method of claim 9, wherein whether the first condition is satisfied or not is determined on the basis of [Equation 1] below:
$$ρ ( Γ A ) < 1 \qquad [ Equation 1 ]$$
where, Γ is a diagonal matrix having as diagonal elements a required Signal-to-Interference-plus-Noise Ratio corresponding to specific UE, and ρ(A) is a spectral radius of matrix A composed of channels and beamforming vectors, which are corresponding to the specific UE.

12. The method of claim 9, wherein the determining of whether the second condition is satisfied or not comprises:
determining whether optimal power allocation corresponding to the UE is within a power allocation range available to a plurality of UEs,
wherein each of the plurality of UEs is UE that has transmitted the use request message for the at least one service to the base station.
